(19) United States
(12) Patent Application Publication
(10) Pub. No.: US 2007/0120463 A1
(43) Pub. Date: May 31, 2007

(54) Phosphor plate and light emitting device having same

(75) Inventors: Toshimasa Hayashi, Aichi-ken (JP); Hideaki Kato, Aichi-ken (JP); Hiroaki Kawaguchi, Aichi-ken (JP); Takumi Narita, Aichi-ken (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(73) Assignee: TOYODA GOSEI, CO., LTD, Aichi-ken (JP)

(21) Appl. No.: 11/581,751

(22) Filed: Oct. 17, 2006

(30) Foreign Application Priority Data
Oct. 26, 2005 (JP) 2005-311624

(51) Int. Cl. H01J 1/62

(52) U.S. Cl. 313/501

(57) ABSTRACT

A phosphor plate has a wavelength conversion plate member formed of a base material with a phosphor included therein. The phosphor is operable to radiate a wavelength-converted light by being excited by a light emitted from a light emitting element. The base material further has a converter of light travel direction.

The present application is based on Japanese patent application No. 2005-311624, the entire contents of which are incorporated herein by reference.

### BACKGROUND OF THE INVENTION

1. Field of the Invention

This invention relates to a phosphor plate to radiate a wavelength-converted light by being excited by light emitted from a light emitting element and to a light emitting device having the same.

2. Description of the Related Art

A light emitting device is practically used which is operable to generate white light by the mixture of light emitted from an LED (=light emitting diode) element and a wavelength-converted light radiated from a phosphor being excited by the emitted light.

JP-A-2005-93712 discloses a light emitting device that comprises: a package having a case opened on the light extraction side; an LED element housed in the case; and a sealing material which seals the LED element and contains a phosphor.

In the light emitting device, when using as the LED element a blue LED element to emit blue light and as the phosphor a yellow phosphor to radiate yellow light by being excited by the blue light, white light can be generate by the mixture of the blue light emitted from the LED element and yellow wavelength-converted light from the yellow phosphor.

However, the light emitting device of JP-A-2005-93712 has following problems (1)-(3).

(1) A part of light emitted from the LED element is absorbed in the sealing material to cause light absorption loss. Therefore, the light extraction efficiency lowers.

(2) Since the phosphor-containing sealing material is in contact with the LED element, the phosphor is easy to deteriorate by heat generated from the LED element during the operation. Therefore, the wavelength conversion efficiency of the phosphor lowers so that the light emitting device cannot have high-brightness emission over a long time.

(3) Since the phosphors are suspended in the sealing material filled in the case, a part of the phosphors may sink down toward the bottom of the case. Therefore, the distribution state of the phosphors deteriorates, and the light path length of light radiated in various directions from the LED element is varied in the phosphor-containing sealing material. As a result, the wavelength conversion in the sealing material cannot be uniformly conducted to cause unevenness in emission color.

### SUMMARY OF THE INVENTION

It is an object of the invention to provide a phosphor plate that is capable of enhancing the light extraction efficiency, having high-brightness emission over a long time, and improving the unevenness in emission color.

It is a further object of the invention to provide a light emitting device having the phosphor plate.

(1) According to one aspect of the invention, a phosphor plate comprises:

a wavelength conversion plate member comprising a base material comprising a phosphor, the phosphor being operable to radiate a wavelength-converted light by being excited by a light emitted from a light emitting element,

wherein the base material further comprises a converter of light travel direction.

In the above invention (1), the following modifications and changes can be made.

(i) The converter comprises a refractive index of n1, the base material comprises a refractive index of n2, and n1≦n2 is satisfied.

(ii) The light emitting element comprises a light emitting diode element.

(iii) The phosphor comprises a phosphor to radiate a white light from a light output surface of the plate member.

(iv) The converter comprises an air bubble.

(v) The converter comprises an particle.

(2) According to another aspect of the invention, a light emitting device comprises:

a case comprising an internal space opened on a light extraction side thereof;

the phosphor plate as defined in (1);

a light emitting element housed in the case and disposed on an opposite side to the light extraction side of the case,

wherein the phosphor plate is disposed on the light extraction side of the case.

<Advantages of the Invention>

In the invention, the light extraction efficiency can be enhanced, the high-brightness emission can be obtained over a long time, and the unevenness in emission color can be improved.

### BRIEF DESCRIPTION OF THE DRAWINGS

The preferred embodiments according to the invention will be explained below referring to the drawings, wherein:

FIG. 1A is a cross sectional view showing a light emitting device in a first preferred embodiment according to the invention;

FIG. 1B is a cross sectional view showing an LED element in FIG. 1A;

FIG. 2 is a cross sectional view showing a light emitting device in a second preferred embodiment according to the invention;

FIG. 3A is a cross sectional view showing a light emitting device in a third preferred embodiment according to the invention; and

FIG. 3B is a perspective view showing a phosphor plate in FIG. 3A.

### DETAILED DESCRIPTION OF THE PREFERRED EMBODIMENTS

### First Embodiment

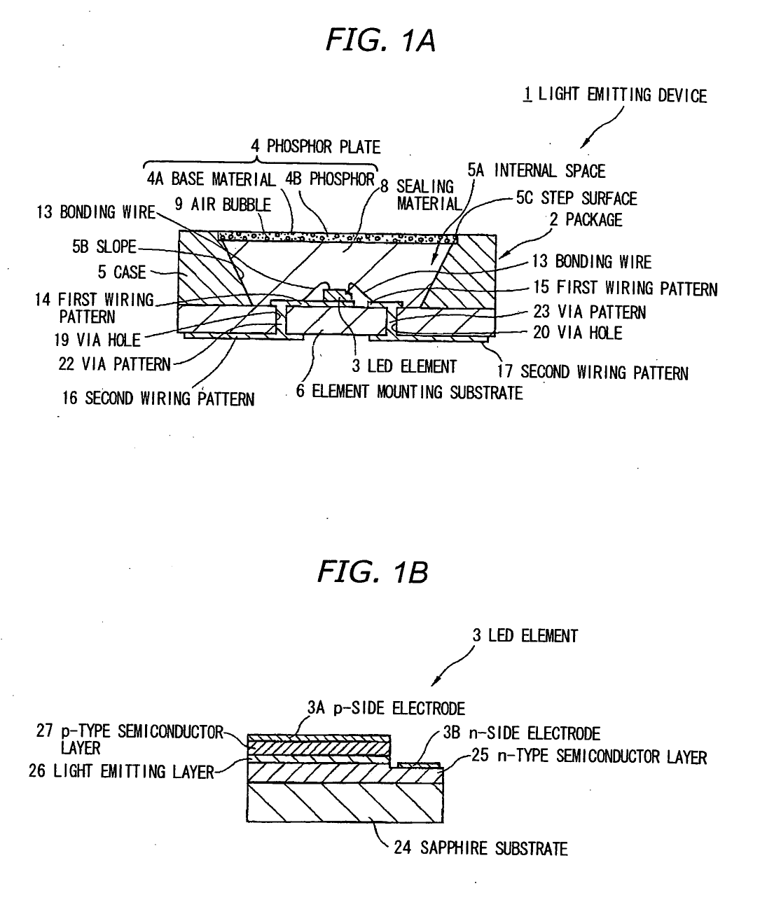

FIG. 1A is a cross sectional view showing a light emitting device in the first preferred embodiment according to the invention. FIG. 1B is a cross sectional view showing an LED element in FIG. 1A.

Light Emitting Device

As shown in FIG. 1A, the light emitting device 1 comprises: a package 2 for housing an LED element 3; the LED element 3 housed in the package 2; a sealing material 8 which is filled in the package 2 and seals the LED element 3; a phosphor plate 4 which is disposed on the light extraction side of the LED element 3 while covering the sealing material 8.

Package

As shown in FIG. 1A, the package 2 comprises a case 5 which houses the LED element 3, and an element mounting substrate 6 which covers an opening on one side (i.e., downside in FIG. 1A) of the case 5.

Case

As shown in FIG. 1A, the case 5 comprises an internal space 5A which is formed circular in plain view and opened in the direction from the substrate side to the light extraction side. The case 5 is, as a whole, box-shaped and formed of a ceramic material such as alumina (Al₂O₃), silicon (Si) and aluminum nitride (AlN), or a white resin. In the case 5, a slope 5B is provided to reflect light emitted from the LED element 3 toward the light extraction side. On the top of the slope 5B, a step surface 5C is provided to attach the phosphor plate 4 to the case 5. The sealing material 8 is filled in the internal space 5A.

Element Mounting Substrate

The element mounting substrate 6 is formed of a ceramic material such as alumina (Al₂O₃), silicon (Si) and aluminum nitride (AlN), or a white resin. On the light extraction side (i.e., the top side) of the element mounting substrate 6, first wiring patterns 14, 15 are formed which are electrically connected through Au (gold) bonding wires 12, 13 to a p-side electrode 3A and an n-side electrode 3B (See FIG. 1B). On the mounting side (i.e., the bottom side) of the element mounting substrate 6, second wiring patterns 16, 17 are formed which serve to supply power to the LED element 3. The first wiring pattern 14 and the second wiring pattern 16 are electrically connected to each other through a via pattern 22 filled in a via hole 19 formed penetrating the element mounting substrate 6. The first wiring pattern 15 and the second wiring pattern 17 are electrically connected to each other through a via pattern 23 filled in a via hole 20 formed penetrating the element mounting substrate 6. The first wiring patterns 14, 15 and the second wiring patterns 16, 17 are formed of a high-melting point metal such as tungsten (W) and molybdenum (Mo) and integrally formed with the via patterns 22, 23.

Optionally, on the surface of the first wiring pattern 15 and the second wiring pattern 17, a metal layer can be provided which comprises a single layer or a multilayer formed of nickel (Ni), aluminum (Al), platinum (Pt), titanium (Ti), gold (Au), silver (Ag) and copper (Cu), or a solder material.

Sealing Material

The sealing material 8 is formed of a transparent resin material such as silicone, epoxy resin and inert gas such as N₂, Ar. The sealing material 8 is disposed between the element mounting substrate 6 and the phosphor plate 4 to seal the LED element 3 in the case 5.

LED Element

The LED element 3 comprises a face-up type blue LED element with the p-side electrode 3A and the n-side electrode 3B as shown in FIG. 1B, sealed with the sealing material 8 as shown in FIG. 1A, and connected through the bonding wires 12, 13 to the first wiring patterns 14, 15. As shown in FIG. 1B, the LED element 3 comprises, grown sequentially on a sapphire (Al₂O₃) substrate 24, an AlN buffer layer (not shown), an n-type semiconductor (n-GaN) layer 25, a light emitting layer 26 and a p-type semiconductor (p-GaN) layer 27. The dimensions of the LED element 3 can be, e.g., about 1 mm in length and width (i.e., plane size).

Phosphor Plate

The phosphor plate 4 comprises, as shown in FIG. 1A, a base material 4A and a phosphor 4B, and is attached to the step surface 5A to define the internal space 5A of the case. The phosphor plate 4 has a uniform thickness in the range of 100 to 500 μm.

The base material 4A is shaped like a thin circular plate and formed of a transparent material with a refractive index of n2 (N2=1.2 to 1.5) greater than n1 (n1=1.0) of the air. The transparent material of base material 4A can be an organic material such as silicone and acryl, an inorganic material such as glass, or a mixed material of the organic material and the inorganic material. The base material 4A includes an air bubble 9 (with the refractive index of n1) which serves as a converter of light traveling direction to convert the traveling direction of light (blue light) emitted from the LED element 3. The air bubble 9 is, e.g., about 100 μm in diameter and accounts for 2 to 3% to the total volume of the phosphor plate 4.

The phosphor 4B is included in the base material 4A. The phosphor 4B is formed of a material such as YAG (yttrium aluminum garnet) to radiate a wavelength-converted light by being excited by the blue light emitted from the LED element 3.

Operation of Light Emitting Device

When a voltage is applied from a power source (not shown) through the second wiring patterns 16, 17, the via patterns 22, 23, and the first wiring patterns 14, 15 to the LED element 3, the light emitting layer 26 of the LED element 3 emits blue light. The light is emitted from the light extraction surface of the LED element 3 to the sealing material 8.

Then, the light emitted from the LED element 3 is irradiated through the sealing material 8 to the phosphor plate 4. In this case, a part of the emitted light from the LED element 3 is irradiated through the sealing material 8 to the phosphor plate 4, and the other part thereof is irradiated through the sealing material 8, reflected on the slope 5B of the case 5, again through the sealing material 8, to the phosphor plate 4.

The phosphor plate 4 (i.e., the phosphor 4B) is excited by the inputted blue light to emit a yellow wavelength-converted light. Thus, the blue light emitted from the LED element 3 is mixed with the yellow light radiated from the phosphor 4B to generate white light. In this case, a part of the blue light inputted in the phosphor plate 4 is irradiated to the air bubble 9 in the phosphor plate 4, and then reflected on the interface of the air bubble 9 to change the traveling direction thereof to be then irradiated to the phosphor 4B. Otherwise, the blue light irradiated to the air bubble 9 is refracted in the air bubble 9, again refracted when outputted from the air bubble 9, and irradiated to the phosphor 4B. Thus, the part of the blue light can be wavelength-converted without being absorbed in the base material 4A, i.e., to suppress the light absorption loss, to generate more white light. Then, the generated white light is outputted outside from the light output surface of the phosphor plate 4.

Effects of the First Embodiment

The following effects can be obtained by the above first embodiment.

(1) A part of the blue light emitted from the LED element 3 can be suppressed from being absorbed in the base material 4A. Therefore, the light absorption loss can be reduced and thereby the light extraction efficiency can be increased about 20 to 30%.

(2) The phosphor 4B can be prevented from deterioration due to heat generated from the LED element 3. Therefore, the wavelength conversion efficiency of the phosphor 4B can be kept high to obtain high-brightness emission over a long time.

(3) The distribution state of the phosphor 4B in the phosphor plate 4 (or the base material 4A) can be kept stable. Further, the path length of light radiated in various directions from the LED element 3 can be kept constant in the phosphor plate 4. Therefore, the wavelength conversion in the phosphor plate 4 can be uniformed to improve the unevenness in emission color.

### Second Embodiment

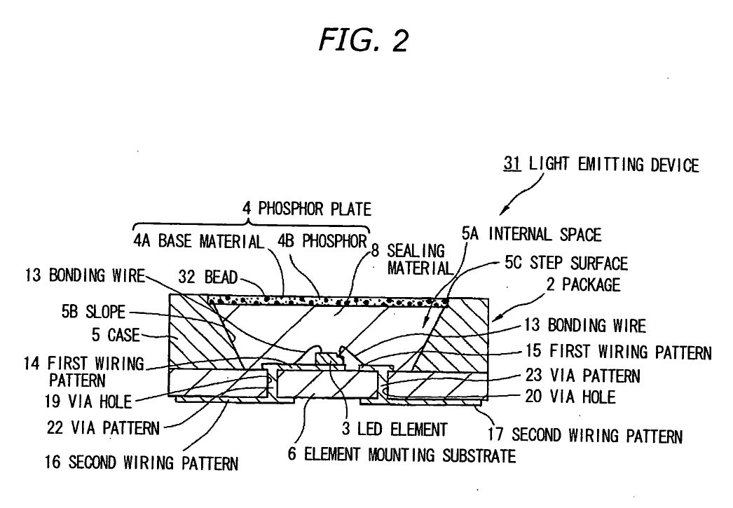

FIG. 2 is a cross sectional view showing a light emitting device in the second preferred embodiment according to the invention. In FIG. 2, like components are indicated by using the same numerals as in FIGS. 1A and 1B and the detailed explanations are omitted below.

As shown in FIG. 2, the light emitting device 31 has the feature that a bead 32 is used as the converter of light traveling direction.

The base material 4A includes the beads 32 (with a refractive index of n3=1.4), which is formed of silica (SiO₂) etc., to covert the traveling direction of blue light emitted from the LED element 3. The bead 32 is, e.g., about 20 to 100 μm in diameter and accounts for 2 to 3% to the total volume of the phosphor plate 4.

Effects of the Second Embodiment

The same effects (1) to (3) as the first embodiment can be obtained by the above second embodiment.

### Third Embodiment

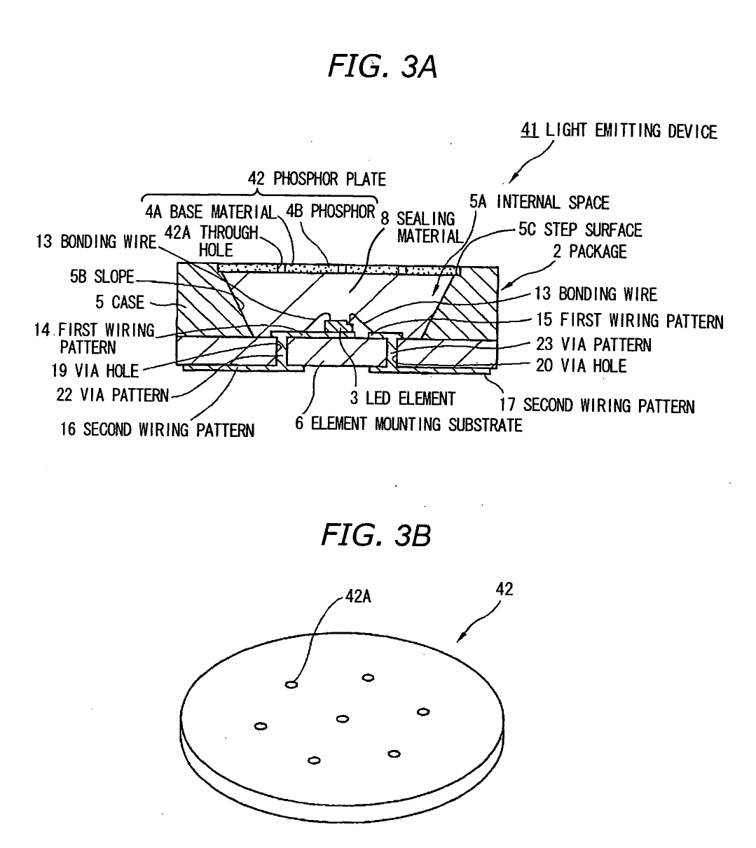

FIG. 3A is a cross sectional view showing a light emitting device in the third preferred embodiment according to the invention. FIG. 3B is a perspective view showing a phosphor plate in FIG. 3A. In FIGS. 3A and 3B, like components are indicated by using the same numerals as in FIGS. 1A and 1B and the detailed explanations are omitted below.

As shown in FIG. 3A, the light emitting device 41 has the feature that it comprises a phosphor plate 42 with a through hole 42 formed therein.

The through hole 42A of the phosphor plate 42 can be a circular hole opened on the light input surface and the light output surface of the phosphor plate 42. An air layer inside of the through hole 42A serves as a converter of light traveling direction.

In operation, a part of the blue light inputted in the phosphor plate 42 from the LED element 3 is reflected on the interface of the air layer inside of the through hole 42A and the base material 4A to change the traveling direction thereof to be then irradiated to the phosphor 4B. Otherwise, a part of the blue light inputted in the air layer of the through hole 42A is refracted in the air layer, again refracted when outputted from the air layer, and irradiated to the phosphor 4B.

Alternatively, the through hole 42A may be filled with a material such as glass with a lower refractive index than the base material 4A.

Effects of the Third Embodiment

The same effects (1) to (3) as the first embodiment can be obtained by the above third embodiment.

Although in the above embodiments the phosphor plates 4, 42 are used to radiate yellow light by being excited by blue light emitted from the LED element 3, a phosphor plate can be used to radiate a white wavelength-converted light by being excited ultraviolet light (with a wavelength of 370 to 390 nm) emitted from an LED element.

Although in the above embodiments the face-up type LED element 3 is used, a face-down LED element 3 can be used. In this case, the LED element 3 is flip-mounted on the first wiring patterns 14, 15.

Although the invention has been described with respect to the specific embodiments for complete and clear disclosure, the appended claims are not to be thus limited but are to be construed as embodying all modifications and alternative constructions that may occur to one skilled in the art which fairly fall within the basic teaching herein set forth.

What is claimed is:

1. A phosphor plate, comprising:
a wavelength conversion plate member comprising a base material comprising a phosphor, the phosphor being operable to radiate a wavelength-converted light by being excited by a light emitted from a light emitting element,
wherein the base material further comprises a converter of light travel direction.

2. The phosphor plate according to claim 1, wherein:
the converter comprises a refractive index of n1,
the base material comprises a refractive index of n2, and
n1≦n2 is satisfied.

3. The phosphor plate according to claim 1, wherein:
the light emitting element comprises a light emitting diode element.

4. The phosphor plate according to claim 1, wherein:
the phosphor comprises a phosphor to radiate a white light from a light output surface of the plate member.

5. The phosphor plate according to claim 1, wherein:
the converter comprises an air bubble.

6. The phosphor plate according to claim 1, wherein:
the converter comprises an particle.

7. A light emitting device, comprising:
a case comprising an internal space opened on a light extraction side thereof;
the phosphor plate as defined in claim 1;
a light emitting element housed in the case and disposed on an opposite side to the light extraction side of the case,
wherein the phosphor plate is disposed on the light extraction side of the case.
